(19) United States
(12) Patent Application Publication
(10) Pub. No.: US 2023/0087808 A1
(43) Pub. Date: Mar. 23, 2023

(54) SYMBOL MAPPING KEY ASSEMBLY, KIT AND PROCESS FOR USE IN ASSEMBLING SUCH AS FOAM BOARD MODEL AIRPLANES AND OTHER REPLICAS

(71) Applicant: Overstreet Investments, Inc., Boonville, MO (US)

(72) Inventor: John L. Overstreet, Fayette, MO (US)

(73) Assignee: Overstreet Investments, Inc., Boonville, MO (US)

(21) Appl. No.: 17/840,861

(22) Filed: Jun. 15, 2022

Related U.S. Application Data
(60) Provisional application No. 63/247,378, filed on Sep. 23, 2021.

(51) Int. Cl. G09B 19/00

(52) U.S. Cl. CPC G09B 19/003; A63H 27/001

(57) ABSTRACT

A kit and assembly for mapping out steps in a build process for constructing a model replica including a mapping key containing a plurality of symbols corresponding to different fabrication operations associated with the build process. One or more template boards are provided, each containing one or more replica parts and having a sub-arrangement or scheme of symbols drawn from the mapping key for providing a subset build step. Assembly of the foam board replica can be expedited, with or without reference to separate instructional videos which can be provided for any specific replica kit.

### CROSS REFERENCE TO RELATED APPLICATIONS

The present application claims the priority of U.S. Ser. No. 63/247,378 filed Sep. 23, 2021.

### FIELD OF THE INVENTION

The present invention relates generally to foam board assemble-able kits. More particularly, the present invention discloses a novel system for mapping out the steps in the build process for constructing model replicas of any type and including a mapping key corresponding to a plurality of symbols provided at various locations (such as by laser etching) on the individual foam board pieces. In this manner, assembly of the foam board replica can be expedited, with or without reference to separate instructional videos which can be provided for any specific replica kit.

### BACKGROUND OF THE INVENTION

The prior art is documented with user assemble-able replica kits, such as in particular for model airplanes and which typically utilizes lightweight woods such as balsa. In recent years, foam board material has been employed in the construction of model airplane kits and which has been found to be an effective rapid build material which can be utilized with adhesives and other construction tools.

An ongoing challenge with existing do-it-yourself model assembly kits (both replica and functional variety with electronics for such as remote controlled flight) is the relative complexity involved with assembly of the model kits and which often relies upon any combination of written and visual/pictorial instructions for assisting in the assembly process.

### SUMMARY OF THE INVENTION

The present invention discloses a process and assembly for mapping out the steps in the build process for constructing model replicas of any type and including a mapping key corresponding to a plurality of symbols additionally provided at various locations (such as by laser etching) on the individual foam board pieces. In this manner, assembly of the replica can be expedited, with or without reference to separate instructional videos which can be provided for any specific replica kit and in order to provide additional details/information to assist in an assembly process.

Each of the template boards contains one or more pre-assembled replica parts having a sub-arrangement of one or more symbols drawn from the mapping key for providing a subset build step. The template boards in one non-limiting application each further include a rigid foam material, with the symbols being laser etched on reverse facing sides of said parts.

The mapping key can utilize any arrangement or compilation of symbols which define specific assembly steps and which, in a non-limiting example, includes a Star shaped symbol representing a first part of the assembly. A cylinder shaped symbol is provided for forming of a part, the edges of which are brought together and glued in order to create a seam.

A semi-circular or Curved shaped symbol indicates a part to be formed so that it creates a curved cross sectional profile. A Wrap and Glue symbol indicates a process of gluing two edges together a portion at a time. A No glue symbol indicates glue is not to be applied in a designated area.

Other aspects of the mapping key include a Stack symbol representing parts that are to be stacked and glued together in multiple layers. The stack symbol further includes an alpha-numeric labeling scheme indicating parts that are included in the stacked arrangement and which are presented in an alpha-numeric order for necessary for correct assembly. The alpha-numeric labeling scheme further includes the parts to be stacked being arranged with their labels facing in a same direction, except in instances in which the letter “M” is present after the symbol, in which the labels will then be mirrored to face outward from one another.

The alpha-numeric labeling scheme further includes parts to be stacked being arranged with their labels facing inwards towards one another if the letter “X” is present after the symbol. A Remove paper symbol indicates a paper to be removed from the template board, such which can also reveal an adhesive backed layer. A Tab and Slot symbol designates where a tabbed component or part fits into a slotted component or part. The Tab and Slot symbol further includes an alpha-numeric reference to ensure the parts are assembled together correctly.

The mapping key further includes a Former symbol indicating where a given part will be glued around. The Former symbol further includes alpha-numeric references to ensure that the parts go together correctly.

The mapping key further includes an Edge to Edge symbol identifying parts that will be attached and glued in an edge-to-edge arrangement. The Edge to Edge symbol further includes an alpha numeric reference to ensure that the parts go together correctly.

A Remove foam symbol indicates that foam is to be removed from a paper backing in relation to a part contained in a given rigid foam board template. An Arrow symbol indicates an area, in many instances which is to be glued first.

A Single bevel symbol indicates a starting point and finishing point of a single bevel and which is found along an edge or along a score line, with one of the two symbols being positioned at a beginning of the bevel and the other symbol being located at the other end of the bevel. A Cut symbol indicates where a cut is to be made in the template board.

A Watch Video symbol prompts the assembler to view a particular instructional video (such as housed on the YouTube® online video library). Finally, a Fold symbol indicates one or more bends or angles to be formed in a part such as following incising material from a hinge defined channel.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an illustration of a mapping key according to one non-limiting application of the present invention and which illustrates a plurality of symbols corresponding to placement on or in proximity to each of the assembly parts, and such as which in turn can be incorporated into removable locations associated with a rigid foam board template;

FIG. 2 is an illustration of a stacking step in addition to depicting a No Glue symbol;

FIG. 3 illustrates each of Single Bevel and Cut symbols for established along an assembled edge of a pair of sandwiched foam board templates;

FIG. 4 is an illustration of a Remove Paper backing step;

FIG. 5 illustrates a Remove Foam step, such as positioned on a reverse face of the template board and depicted by a symbol representing an area where foam is to be removed;

FIG. 6 illustrates a foam template board and depicting a combination of mapping symbols associated with the given assembly step;

FIG. 7 provides a succeeding illustration depicting a watch video symbol engraved on a selected part and prompting the assembler to view a subset instructional video relevant to a specific assembly step or substep;

FIG. 8 depicts another removable template part from a foam board and including a collection of symbols from the mapping key including Cut, No Glue, Single Bevel and Stack protocols;

FIG. 9 is a depiction of a further template part illustrating each of Edge to Edge and Stack symbols;

FIG. 10 illustrates a further template part mate-able in edge to edge aligning fashion with the template part of FIG. 9;

FIG. 11 illustrates a selected template board with a plurality of removable parts or portions corresponding to the given build assembly steps; and

FIG. 12 presents an illustration of a completed model replica constructed with the assistance of the symbol mapping scheme of the present invention.

### DETAILED DESCRIPTION OF THE PREFERRED EMBODIMENTS

With reference to the attached illustrations, the present invention discloses a process and kit assembly for mapping out the steps of a build process for constructing a model replica of any type, such as in one non-limiting embodiment including radio controlled model airplane designs. In particular, the present invention includes a mapping key corresponding to a plurality of symbols additionally provided at various locations (such as by laser etching) on each of a plurality of individual foam board templates, each of these containing sub-pluralities of the parts associated with the replica build process.

In this manner, assembly of the foam board replica can be expedited, utilizing adhesives and other construction tools typical with the build process, and with or without reference to separate instructional videos which can be provided for any specific replica kit in order to provide additional details/information to assist in an assembly process. An example of a completed build replica is shown in reference to the airplane design 2 of FIG. 12. Without limitation, the replica kit can also include operable remote controlled aircraft including such as landing gear (where applicable), portable electric motors, power supplies and processor driven remote receiver (also termed as a servo) operated by such as a user operable remote transmitter/controller.

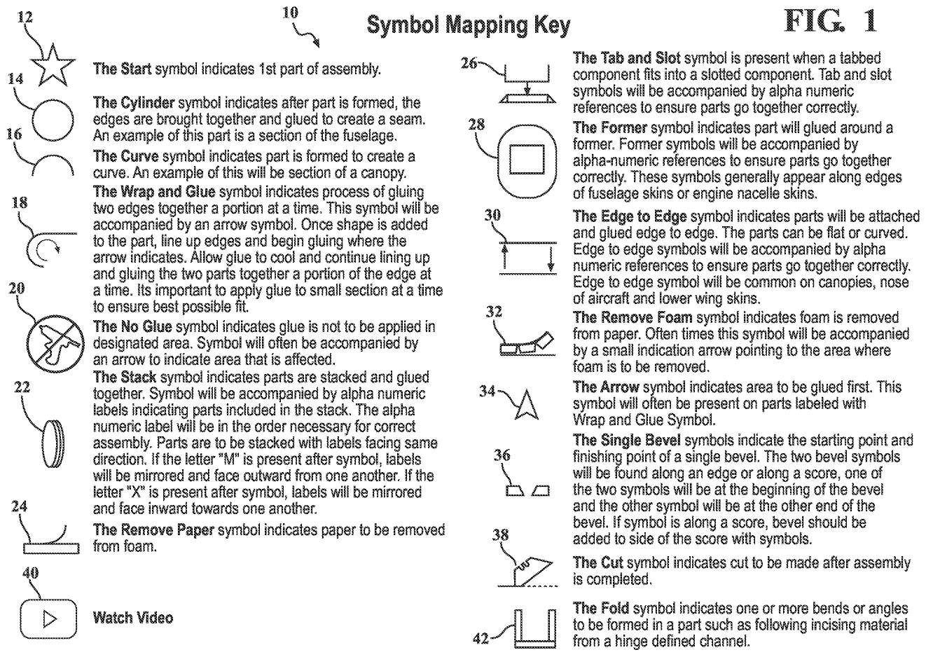

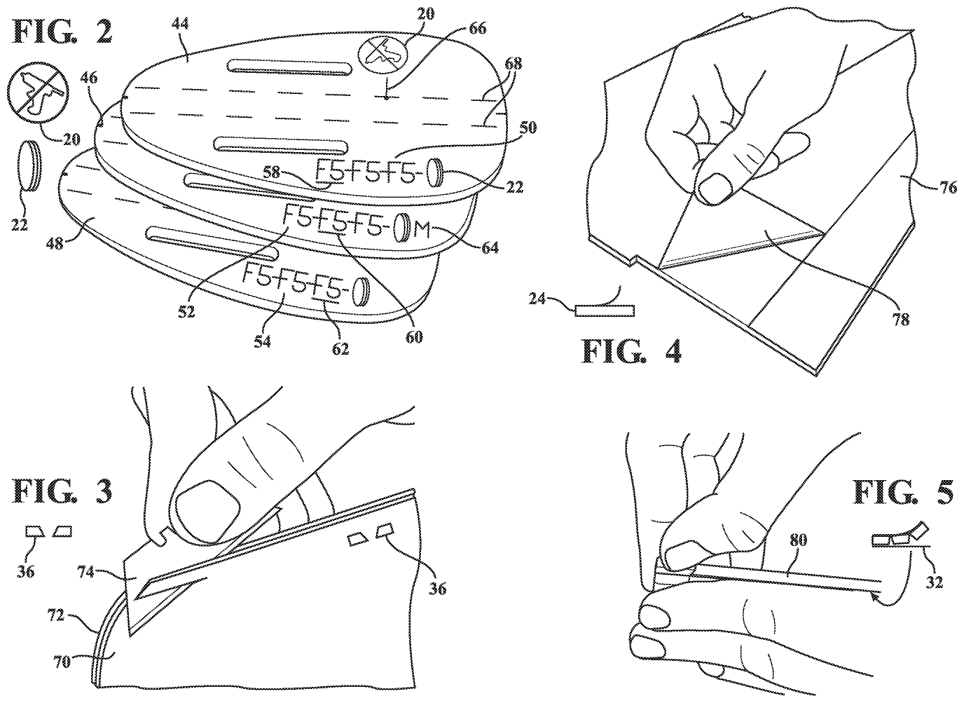

Referring first to FIG. 1, an illustration is shown of a mapping key, generally at 10, according to one non-limiting application of the present invention and which illustrates a plurality of symbols corresponding to placement on or in proximity to each of the assembly parts, and such as again which in turn can be incorporated into removable locations associated with any number of rigid foam board templates (and as further shown in succeeding FIGS. 2-11). It is understood that the particular design of each of the mapping or build symbols can be engraved on the various parts and associated with each built step can be varied from that shown, so long as they are consistent with what is depicted upon the mapping key. As further understood, the various inscription schemes depicted in FIGS. 2-11 can be engraved or otherwise indicia applied on reverse (or hidden faces) of the template parts such that, and upon completed assembly, these are hidden from view.

Although not shown, it is understood that the assembly process is aided by additional tools including such as adhesives (most typically a fast drying hot glue applied from a suitable glue gun) as well as incising tools including such as a box cutter with razor blades, knives and the like. As also described, other assembly aids can optionally include on-line accessible construction videos which are particular to a specific build application and which can provide supporting instructional techniques and information complementary to the interpretation and use of the mapping key symbols of the present invention.

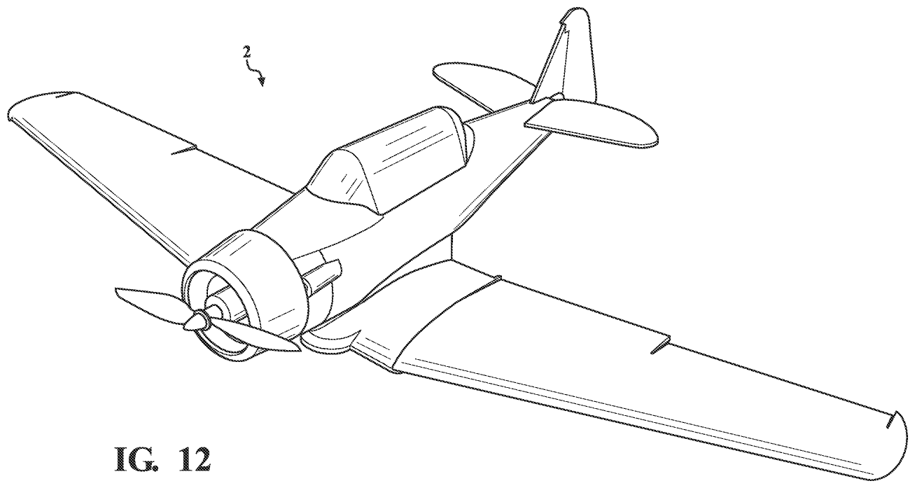

As will be described, the instructional mapping symbols are provided in any needed arrangement associated with the various subset pluralities of parts incorporated into each of the rigid foam board templates (see again as shown by selected template board in FIG. 11). In a non-limiting preferred application, the mapping symbols are further laser etched such as to underside (further identified as hidden or non-finished) surfaces of each of the parts (such that these are not evident in the completed model replica 2 depicted in FIG. 12). As further described in reference to FIG. 11, the individual parts are in turn supported in detachable fashion from any number of rigid foam board template sheets provided for the given build project.

The start process is represented by a star shaped symbol or icon 12 (these terms understood to be in use interchangeably) and which represents a first part of the assembly. It is further understood that the icons/symbols 12-38 depicted in the mapping key of FIG. 1 are not intended to follow any specific order and that these can correspond to any arrangement or distribution in reference to the assembleable parts shown by non-limiting example in each of FIGS. 2-7.

A cylinder shaped symbol or icon 14 instructs, following forming of a part, the edges of which are brought together and glued in order to create a seam.

Semi-circular or curved shaped symbol 16 indicates a part to be formed so that it creates a curved cross sectional profile. This is typical of a section or a canopy of fuselage associated with the model airplane build.

Wrap and Glue symbol 18 is provided to indicate a process of gluing two edges together a portion at a time. This is usually accompanied by arrow symbol (see as further shown at 34) and once shape is added to the part, the edges are lined up, and glue applied where the arrow symbol indicates. According to this process, the glue application is allowed to cool, with the assembler continuing to line up and glue the two parts together along a portion of the edge at a time (the understanding being that applying glue to small sections at a time ensures the best possible fit).

No glue symbol 20 indicates glue is not to be applied in a designated area. The symbol will also often be accompanied by arrow symbol 34 indicating the area that is affected.

Stack symbol 22 represents parts that are to be stacked and glued together in multiple layers. The symbol is accompanied by an alpha-numeric labeling scheme indicating the parts that are included in the stacked arrangement and which are presented in an alpha-numeric order for necessary for correct assembly. Parts to be stacked are arranged with their labels facing in a same direction, except in instances in which the letter “M” is present after the symbol, in which the labels will then be mirrored to face outward from one another. Alternatively, and if the letter “X” is present after the symbol, the labels will be arranged to that they are mirrored in a fashion that they face inwards toward one another.

Remove paper symbol 24 indicates a paper to be removed from the foam board, such which can also reveal an adhesive backed layer. Tab and Slot symbol 26 designates where a tabbed component or part fits into a slotted component/part. The Tab and Slot symbol is accompanied by an alpha-numeric reference as needed to ensure that the parts are assembled correctly together.

Former symbol 28 indicates where a given part will be glued around a former. Former symbols are accompanied by alpha-numeric references to ensure that the parts go together correctly and generally appear along edges of such as the fuselage skins or engine nacelle skins.

Edge to Edge symbol 30 identifies parts that will be attached and glued in an edge-to-edge arrangement. Such parts can be flat or curved and the symbol 30 is accompanied by alpha numeric references to ensure that the parts go together correctly. Use examples of the edge to edge symbol 30 include canopies, nose of the aircraft and lower wing skins.

Remove foam symbol 32 indicates that foam is to be removed from a paper backing in relation to a part contained in a given rigid foam board template. This symbol is often accompanied by a small indication arrow pointing to an area where the foam is to be removed.

Arrow symbol 34 (previously referenced) indicates an area, in many instances which is to be glued first. As previously noted, this symbol is often present on parts labeled with the Wrap and Glue Symbol 18.

Single bevel symbol 36 indicate a starting point and finishing point of a single bevel and is found along an edge or along a score line, with one of the two symbols being positioned at a beginning of the bevel and the other symbol being located at the other end of the bevel. If the bevel symbol 36 is located along a score line, a bevel should be added to a side of the score with symbols.

Cut symbol 38 indicates where a cut is to be made (such as again with the use of a box cutter or other incising device), and such as after assembly is completed. A Watch Video symbol 40 prompts the assembler to view a particular instructional video (such as housed on the YouTube® online video library). Finally, a Fold symbol 42 indicates one or more bends or angles to be formed in a part such as following incising material from a hinge defined channel.

Referring now to FIG. 2, an illustration is provided of each of a Stacking symbol 22 in addition to depicting a No Glue symbol 20 provided in association with a plurality of individual template removed parts or pieces shown at 44, 46 and 48. By way of general explanation the Stack symbol 22 contemplates the assembly, such as by gluing, of the multiple pieces or parts depicted, these including individual engraved depictions for facilitating the arrangement or stacking of the parts associated with the assembly and gluing step.

In particular, each of the parts 44, 46 and 48 depict a given stacking arrangement or scheme, such as shown by the matching schemes F5-F5-F5 (see respectively at 50, 52 and 54). These can further include underlined portions (see underlined portion at 56 for scheme 50, further at 58 for scheme 52 and at 60 for scheme 54 which identify the order in which the given stack of parts are arranged). Second or middle part 46 further includes a Mirror representation 64 which designates that the part is to be flipped over or reversed relative to the top referenced part 44 (identified by the F5-F5-F5 scheme 58) and the bottom referenced part 48 (identified by the F5-F5-F5 scheme) and prior to gluing the parts together. No Glue symbol 20, as depicted in upper part 44, further references by directional arrow 66 a designated area (see as defined by hash marks 68) in which glue is not to be applied.

The alpha-numeric labeling scheme further contemplates parts to be stacked alternatively being arranged with their labels facing inwards towards one another if the letter “X” is present after the symbol, and as opposed to the Mirror symbol (M) 64.

It is also understood that additional schemes or representations are depicted in selected part views of FIG. 2 et seq. which correspond to portions of an exemplary replica build assembly and, in the illustrated embodiment, and can include part designations using the terms F, C, H, and the like representative of each of the fuselage, wings, canopy, horizontal/vertical stabilizer, etc., corresponding to a replica airplane build kit. The particular use of the letter designations can be varied and tailored to a given build assembly (e.g. so many parts associated with each of the airplane fuselage, wing, canopy and other sub-assemblies which need to be stacked and glued in earlier build steps and prior to progressing to subsequent assembly steps).

FIG. 3 illustrates each of Single Bevel 36 symbol for established along an assembled edge of a pair of sandwiched foam board templates or parts 70 and 72. The purpose of this view is to depict the utilization of an incising portion (such as razor blade shown at 74) by the assembler in order to perform an edge removal incision in order to create a desired bevel profile.

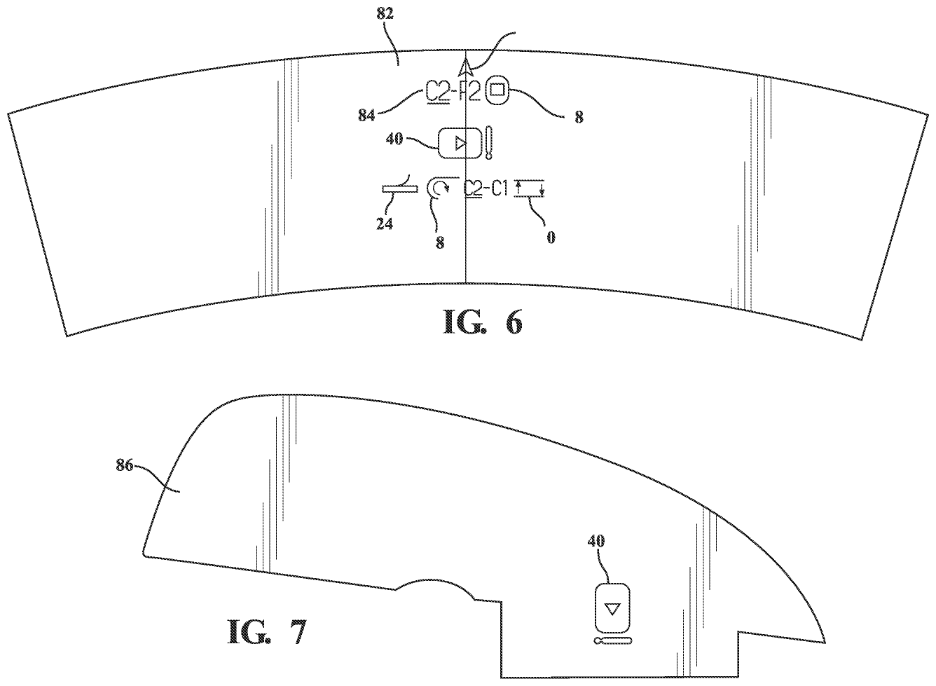

FIG. 4 is an illustration of a Remove Paper backing step depicted at 24 to represent the separation of the foam from the paper backing. This is further shown by part 76 with paper backing 78 being peeled away. FIG. 5 illustrates a Remove Foam step 32, such as positioned on a reverse face of a template board 80 and depicted by a symbol representing an area where foam is to be removed;

Proceeding to FIG. 6, illustrated is a foam template board or part 82 depicting a combination of mapping symbols associated with the given assembly step. As represented by symbol 28, this indicates that the part 82 will be glued or otherwise adhesively secured about a former (not shown). As previously noted, former symbols are accompanied by alpha-numeric references to ensure that the specified parts are correctly assembled together. As further shown, these symbols generally appear along the edges of the part fuselage skins or engine nacelle skins corresponding to the given replica build (see again at 2 in FIG. 12).

Scheme C2-F2 again represents a two layer configuration of parts in which the upper part C2 or layer/tier can be formed about a lower former layer or tier F2. Additional symbol references incorporated into the selected part 82 can include from those drawn from the mapping key 10 of FIG. 1 and include each of Remove Paper symbol 24, Wrap and Glue symbol 18 and Edge to Edge symbol 30 as previously described.

Specifically, Edge to Edge symbol 30 identifies parts that will be attached and glued in an edge-to-edge arrangement. Such parts can be flat or curved and the symbol 30 is accompanied by alpha numeric references to ensure that the parts go together correctly. Use examples of the edge to edge symbol 30 include canopies, nose of the aircraft and lower wing skins.

In the further instance of Wrap and Glue symbol 18, this is again provided to indicate a process of gluing two edges together a portion at a time and is usually accompanied by arrow symbol (see as additionally shown at 34 for part 82) and once shape is added to the part, with the edges are lined up, and glue applied where the arrow symbol indicates.

FIG. 7 provides a succeeding illustration of a part 86 which, along with FIG. 6, both depict a Watch Video symbol 40 prompting the assembler to view a particular instructional video (such as housed on the YouTube® online video library). The objective of the supporting aids to the symbol mapping process (including the mapping key, instructional videos and the like) is to facilitate the build process by simplifying and reducing the time necessary for the assembler to acquire the requisite information for completing the replica build, this by providing an intuitive mapping scheme and some basis instructions (including where to go to acquire additional information on an as-needed basis).

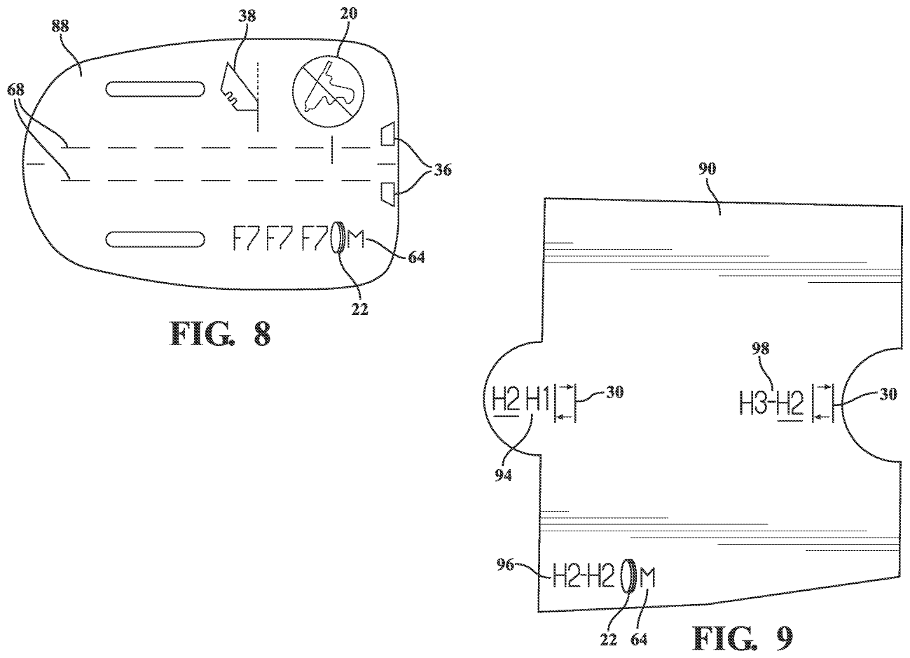

FIG. 8 depicts another removable template part 88 from a foam board and including a collection of symbols from the mapping key including Cut 38, No Glue 20, Stack 22 and Single Bevel 36 (this again indicating a starting point and finishing point of a single bevel and is found along an edge or along a score line, with one of the two symbols being positioned at a beginning of the bevel and the other symbol being located at the other end of the bevel which, if located along a score line, requires a bevel be added to a side of the score with symbols). Other symbols again include hash mark representations 68 (similar to those shown in the related part of FIG. 2) and such as identifying areas where glue application is to be avoided.

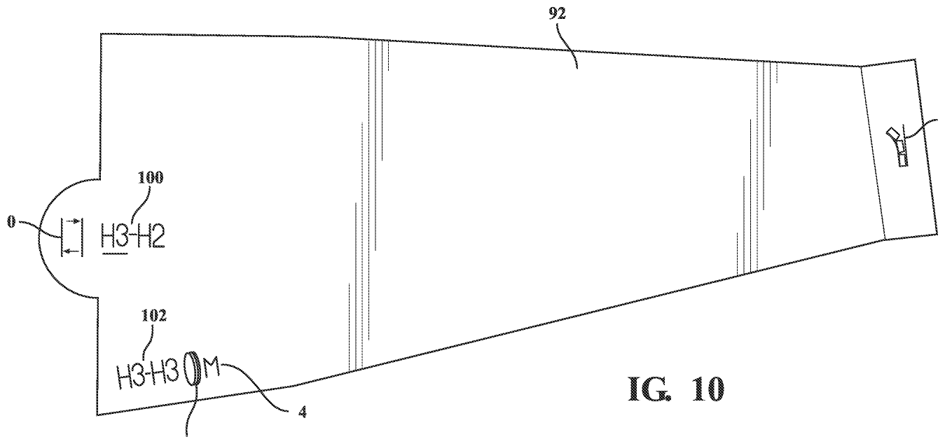

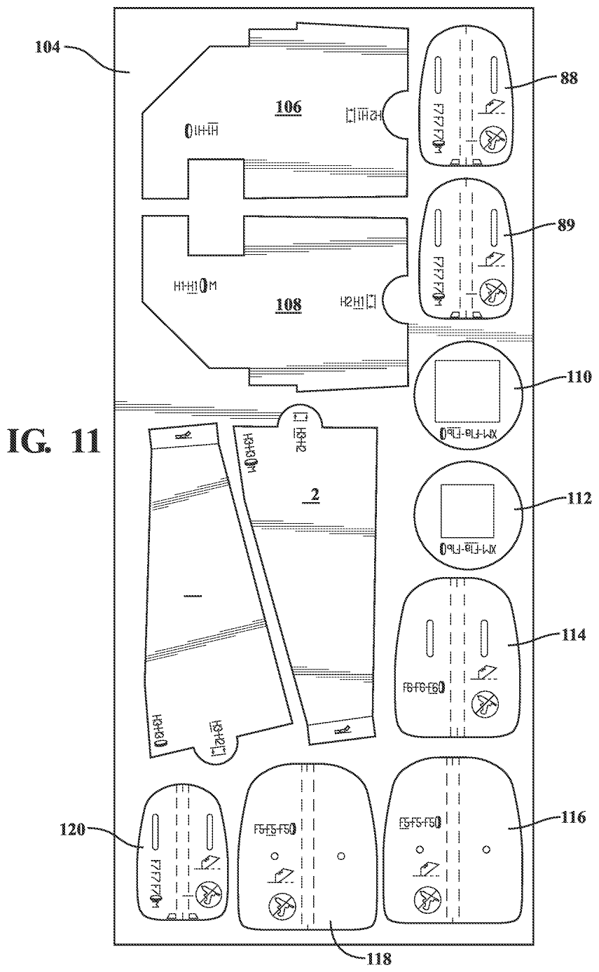

FIGS. 9 and 10 are viewed collectively, with FIG. 9 providing a depiction of a further template part 90 illustrating each of Edge to Edge 30 and Stack 22 symbols, and FIG. 10 illustrating a further template part 92 mate-able in edge to edge aligning fashion with the template part 90 of FIG. 9 and further depicting Remove Foam symbol 32. As previously described, the parts 90 and 92 each include alphanumeric reference schemes.

For part 90 these are shown at H2-H1 94, H2-H2 96 (with mirroring designation symbol M 64) and H3-H2 98. For part 92 these are shown by schemes H3-H2 100, this combined with Edge to Edge symbol 30 for matching the mirroring arrangement of scheme H3-H2 98 in part 90 also with Edge to Edge symbol 30 for arranging the parts 90 and 92 in edge-to-edge aligning fashioning. Also shown in part 92 is scheme H3-H3 102 with Stack symbol 22 and reverse Mirror representation (again at 64) which designates that the part is to be flipped over or reversed relative to a succeeding layered part according to the desired stacking protocol.

As again previously described, the parts 90 and 92 shown in FIGS. 9-10 can be flat or curved, with the Edge to Edge symbol 30 accompanied by alpha numeric references to ensure that the parts go together correctly (use examples of the edge to edge symbol 30 again include without limitation such as assembly of canopies, nose of the aircraft and lower wing skins).

FIG. 11 illustrates a selected foam template board 104 exhibiting a plurality of removable template portions corresponding to the parts utilized in the build kit and assembly. The template removable parts include again those as previously shown at 88 and 92 (with mirroring parts 89 and 93, respectively) as well as additional parts 106, 108, 110, 112, 114, 116, 118 and 120, each of which depicting a varying sub-arrangements of the mapping symbols of FIG. 1 and corresponding alphanumeric schemes which are consistent with the teachings provided.

Without limitation, the symbol mapping key 10 is provided in combination with the etched or otherwise, imprinted symbol scheme (including the individual symbol mapping representations 12-42 depicted in FIG. 1) distributed across such as the rear surfaces of the various template sheet containing parts and for providing a fast and efficient mechanism for identifying an assembly process or protocol associated with the given build project. It is also understood that a typical replica build kit will include several template sheets or boards similar to 104 which include various pluralities of individual removable foam board parts utilized in the overall build process. Additional to the symbols represented in the mapping key 10 presented in FIG. 1, other and additional mapping symbols can be utilized depending upon a specific build project which follows similar protocols.

Having described my invention, other and additional preferred embodiments will become apparent to those skilled in the art to which it pertains, and without deviating from the scope of the appended claims. The detailed description and drawings are further understood to be supportive of the disclosure, the scope of which being defined by the claims. While some of the best modes and other embodiments for carrying out the claimed teachings have been described in detail, various alternative designs and embodiments exist for practicing the disclosure defined in the appended claims.

The foregoing disclosure is further understood as not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosure. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application. Additionally, any signal hatches in the drawings/figures should be considered only as exemplary, and not limiting, unless otherwise specifically specified.

1. A kit assembly for constructing a model replica, comprising:
a mapping key presenting a plurality of symbols corresponding to different fabrication operations associated with a build process for the replica; and
one or more template boards, each containing one or more replica parts exhibiting indicia symbols drawn from the mapping key.

2. The invention as described in claim 1, said template boards each further comprising a rigid foam material.

3. The invention as described in claim 1, further comprising said symbols being laser etched on reverse facing sides of said parts.

4. The invention as described in claim 1, said mapping key further comprising a Star shaped symbol representing a first part of the assembly.

5. The invention as described in claim 1, said mapping key further comprising a Cylinder shaped symbol for forming of a part, the edges of which are brought together and glued in order to create a seam.

6. The invention as described in claim 1, said mapping key further comprising a Semi-circular or Curved shaped symbol indicating a part to be formed so that it creates a curved cross sectional profile.

7. The invention as described in claim 1, said mapping key further comprising a Wrap and Glue symbol provided to indicate a process of gluing two edges together a portion at a time.

8. The invention as described in claim 1, said mapping key further comprising a No glue symbol indicating glue is not to be applied in a designated area.

9. The invention as described in claim 1, said mapping key further comprising a Stack symbol representing a plurality of said replica parts that are to be stacked and glued together in multiple layers.

10. The invention as described in claim 9, said Stack symbol further comprising an alpha-numeric labeling scheme indicating parts that are included in the stacked arrangement and which are presented in an alpha-numeric order for necessary for correct assembly.

11. The invention as described in claim 10, said alpha-numeric labeling scheme further comprising parts to be stacked being arranged with their labels facing in a same direction, except in instances in which the letter “M” is present after the symbol, in which the labels will then be mirrored to face outward from one another.

12. The invention as described in claim 10, said alpha-numeric labeling scheme further comprising parts to be stacked being arranged with their labels facing inwards towards one another if the letter “X” is present after the symbol.

13. The invention as described in claim 1, said mapping key further comprising s Remove paper symbol indicating a paper to be removed from the template board, such which can also reveal an adhesive backed layer.

14. The invention as described in claim 1, said mapping key further comprising a Tab and Slot symbol designating where a tabbed component or part fits into a slotted component/part.

15. The invention as described in claim 14, said Tab and Slot symbol further comprising an alpha-numeric reference to ensure the parts are assembled correctly together.

16. The invention as described in claim 1, said mapping key further comprising a Former symbol indicating where a given part will be glued around a former.

17. The invention as described in claim 16, said Former symbol further comprising alpha-numeric references to ensure that the parts go together correctly.

18. The invention as described in claim 1, said mapping key further comprising an Edge to Edge symbol identifying parts that will be attached and glued in an edge-to-edge arrangement.

19. The invention as described in claim 18, said Edge to Edge symbol further comprising an alpha numeric reference to ensure that the parts go together correctly.

20. The invention as described in claim 1, said mapping key further including a Remove foam symbol indicating that foam is to be removed from a paper backing in relation to a part contained in a given rigid foam board template.

21. The invention as described in claim 1, said mapping key further comprising an Arrow symbol indicating an area, in many instances which is to be glued first.

22. The invention as described in claim 1, said mapping key further comprising a Single bevel symbol indicating a starting point and finishing point of a single bevel and which is found along an edge or along a score line, with one of the two symbols being positioned at a beginning of the bevel and the other symbol being located at the other end of the bevel.

23. The invention as described in claim 1, said mapping key further comprising a Cut symbol indicating where a cut is to be made in the template board.

24. The invention as described in claim 1, said mapping key further comprising a fold symbol indicating one or more bends or angles to be formed in a part such as following incising material from a hinge defined channel.
